(19) United States
(12) Patent Application Publication
(10) Pub. No.: US 2026/0045741 A1
(43) Pub. Date: Feb. 12, 2026

(54) ELECTRICAL CONNECTORS AND SYSTEMS THEREOF INCLUDING CONNECTOR POSITION ASSURANCE MEMBER

(71) Applicant: J.S.T. Corporation, Farmington Hills, MI (US)

(72) Inventors: Ping CHEN, Novi, MI (US); Gwendolyn UPSON, Ypsilanti, MI (US); Jihyun Craig LEE, Torrance, CA (US)

(21) Appl. No.: 19/294,743

(22) Filed: Aug. 8, 2025

Related U.S. Application Data
(60) Provisional application No. 63/681,409, filed on Aug. 9, 2024.

(51) Int. Cl. H01R 13/639; H01R 13/641

(52) U.S. Cl. CPC H01R 13/639; H01R 13/641; H01R 2201/26

(57) ABSTRACT

A connector position assurance member is provided. The connector position assurance member may include a center beam, an upwardly extending deflecting arm extending from a top surface of the center beam, and a front wall having a grip portion. Further, the front wall may be concave and the upwardly extending deflecting arm may have an edge configured to abut a bridge of a female housing. The connector position assurance may have a lateral beam extending from the front wall and generally parallel to the center beam, and a rib engaging the lateral beam. The connector position assurance member may have a brace extending between the lateral beam and the center beam, and the brace may define a pocket with the center beam.

### CROSS REFERENCE TO RELATED APPLICATIONS

This application claims the benefit of U.S. Provisional Application No. 63/681,409, filed Aug. 9, 2024, which incorporated herein by reference in its entirety.

### FIELD OF THE INVENTION

The present disclosure relates to connectors. In particular, aspects relate to an electrical connector with connector position assurance.

### BACKGROUND OF THE INVENTION

An electrical connector can be used in various wiring systems, e.g. vehicle wiring. Electrical connectors can include a male housing, a female housing, and a connector position assurance member. The male housing and female housing can be coupled to each other with connector position assurance to resist disconnection and therefore maintain the electrical connection. A connector position assurance member can move to a final lock position to assure coupling of the male housing and female housing, and the electrical connector can move to a fully mated position when the male housing and female housing are coupled. Movement to the final lock position and fully mated position can provide feedback, assuring the coupling of the male housing and a female housing. The connector position assurance member can be released and the connector housings decoupled for electrical connector maintenance.

### BRIEF SUMMARY OF THE INVENTION

An aspect provides a connector position assurance member configured to couple a first housing and a second housing. The connector position assurance member can include a front wall at a first height; a medial wall extending perpendicularly from the front wall at a second height lower than the first height; a lateral beam at a third height lower than the second height; and a center beam adjacent to the lateral beam. In an aspect, the center beam can include an inclined bottom surface. In another aspect, the lateral beam can include one or more outwardly extending protrusions to engage one or more surfaces of a housing.

In another aspect, the connector position assurance member has a reduced size to mate with a miniaturized connector. For example, some aspects include a shorter and wider center beam relative to other designs. Further, some aspects include a brace reinforcing the center beam and one or more lateral beams. Additional aspects include ribs that reinforce the one or more lateral beams.

Another aspect includes a flared front wall forming a grip. This grip provides an ergonomic structure for individuals to grasp the connector position assurance member when inserting the connector position assurance member into, or removing it from, a female housing.

Another aspect provides an aperture formed in a medial portion of the connector position assurance member's front wall. The aperture allows vision systems, such as robotic vision systems, to measure locking portions of the female housing and subsequently reject parts that exceed tolerances or otherwise do not conform to design requirements for the connector.

### BRIEF DESCRIPTION OF THE DRAWINGS/FIGURES

The accompanying drawings, which are incorporated herein and form part of the specification, illustrate aspects and, together with the description, further serve to explain the principles of the aspects and to enable a person skilled in the relevant art(s) to make and use the aspects.

FIG. 1 is a perspective view of a connector position assurance member secured within a female housing according to various aspects;

FIG. 2 is a perspective view of a connector position assurance member according to various aspects;

FIG. 3 is a different perspective view of the connector position assurance member of FIG. 2;

FIG. 4 is a different perspective view of the connector position assurance member of FIG. 2;

FIG. 5 is a perspective view of a female housing according to various aspects;

FIG. 6 is a top view of the connector position assurance member of FIG. 2;

FIG. 7 is a bottom view of the connector position assurance member of FIG. 2;

FIG. 8 is a side view of the connector position assurance member of FIG. 2;

FIG. 9 is a perspective view a connector position assurance member according to various aspects;

FIG. 10 is a top view of FIG. 1;

FIG. 11 is a cross-sectional view of the connector position assurance member of FIG. 1 and the female housing of FIG. 5 in a pre-installed configuration;

FIG. 12 is a front view of the connector position assurance member of FIG. 2;

FIG. 13 is a front view of FIG. 1;

FIG. 14 is a perspective cross-sectional view of FIG. 1;

FIG. 15 is a side cross-sectional view of FIG. 1;

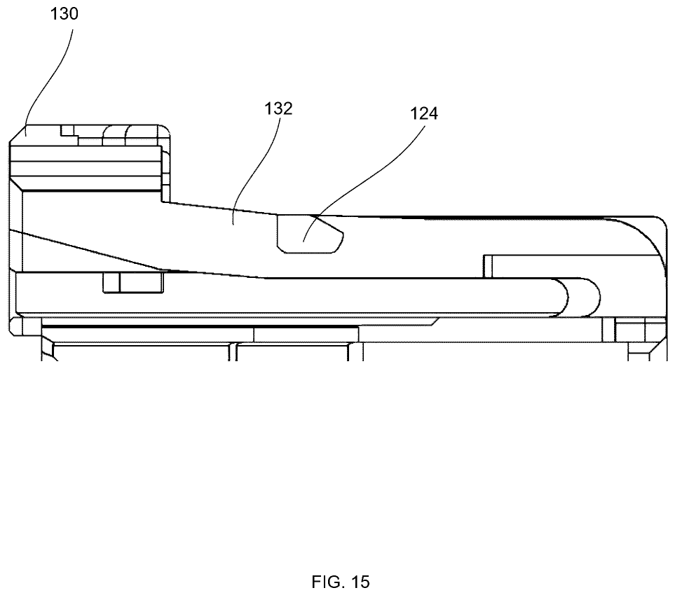

FIG. 16 is a front view of a connector position assurance member according to various aspects;

FIG. 17 is a rear view of FIG. 16;

FIG. 18 is a front view of a connector position assurance member according to various aspects.

### DETAILED DESCRIPTION

The present invention(s) will now be described in detail with reference to aspects thereof as illustrated in the accompanying drawings. References to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The following examples are illustrative, but not limiting, of the present aspects. Other suitable modifications and adaptations of the variety of conditions and parameters normally encountered in the field, and which would be apparent to those skilled in the art, are within the spirit and scope of the disclosure.

As used herein, the term “approximately” is inclusive of the number to which it refers and includes numbers that bound and are within a range of 5%, 10%, 15%, or 20% except where such number would exceed 100% of a possible value.

Aspects provide an electrical connector for a wiring system, such as a vehicle wiring system. The electrical connector described herein can have improved connector position assurance. The electrical connector can include a female housing, a male housing, and a connector position assurance member (“CPA member”). The female housing and the CPA member can form an assembly that can be coupled to the male housing with position assurance. Position assurance is important in wiring systems to ensure and maintain terminal mating and resist disconnection. To ensure coupling, a higher force can be required to couple the assembly with the male housing. The coupling can be intentionally released for maintenance by overcoming the resistance to disconnection. The CPA member can be released to allow decoupling of the female housing and male housing. Advantageously, feedback (e.g., a visual, tactile, and/or auditory feedback) can be provided to signal that the connector housings are coupled with position assurance. The CPA member described herein can additionally have a low profile and a short length and width to limit the size of the electrical connector. The coupling with connector position assurance between the assembly and the male housing can move the electrical connector from a pre-mate position to a fully mated position

The CPA member can have one or more lateral beams that can be received by the grooves of the female housing. The CPA member can further have one or more ribs adjacent to the lateral beams to efficiently reinforce the lateral beams. The ribs can have, for example, variable thickness and height to selectively stiffen portions of the lateral beams subject to high stress. The ribs therefore adequately stiffen the lateral beams without introducing undesirable rigidity. Rigidity may be undesirable where, for example, the lateral beams flex to lock into the female housing.

As described herein, the lateral beams can include one or more protrusions that extend outwardly to fill the clearance between the lateral beams and the grooves of the female housing. As such, the protrusions of the CPA member can tightly fit the CPA member into the grooves of the female housing. The fit can provide anti-buzz, squeak, and rattle (BSR) effects from the electrical connector when installed in a vehicle, for example. BSR effects, such as rattling, can be undesirable. The CPA member described herein can include the protrusions along sides of its lateral beams. The fit between the CPA member and the female housing can limit relative motion between the CPA member and the female housing to reduce or eliminate BSR effects. The fit can also support connector position assurance by maintaining a strong coupling between the female housing and the CPA member.

The assembly including the female housing and the CPA member can be pre-installed. Accordingly, a user does not have to couple the CPA member to the female housing. To support connector position assurance when coupling the assembly to the male housing, the assembly can be prevented from being taken apart. In this way, the CPA member can be prevented from being decoupled from the female housing which can damage the assembly. The grooves of the female housing can include one or more retention detents that fit with one or more cutouts on the lateral beams of the CPA member to retain the CPA member and prevent decoupling of the assembly.

The CPA member can include a center beam that can deflect to move from a pre-lock position to a final lock position such that the electrical connector can move from the pre-mate position to the fully mated position. In the pre-lock position, a deflecting arm that can extend upward from a top surface of the CPA member center beam can be aligned with a flexible bridge of the female housing along a transverse axis generally parallel to the top surface of the CPA member center beam. As described herein, the upward direction can be a longitudinal direction generally parallel to a longitudinal axis. The bridge can abut and engage with an edge of the CPA member in this position. The bridge does not cause the center beam of the CPA member to deflect in this position. Instead, the bridge and CPA member are in blocking engagement such that the CPA member does not deflect and cannot advance generally along a flat plane toward the rear of the female housing. Accordingly, the bridge does not initiate advancement of the CPA member to the final lock position.

A deflecting arm that can extend downward from a top of the male housing can initiate advancement of the CPA member to the final lock position. As described herein, the downward direction can be a longitudinal direction generally parallel to a longitudinal axis. In the pre-lock position, the lock arm of the male housing can abut and engage with the flexible bridge. In an aspect, the lock arm can be aligned with the flexible bridge of the female housing along a transverse axis generally parallel to the top of the male housing. The assembly of the female housing and the CPA member can be advanced toward a rear of the male housing, causing the lock arm of the male housing and the flexible bridge to move out of the transverse alignment. As the assembly is advanced, the lock arm of the male housing can depress the flexible bridge away from its initial position. The lock arm of the male housing, applying a load generally perpendicular to a transverse axis of the flexible bridge, can depress the flexible bridge such that the components can move into alignment along a longitudinal axis generally perpendicular to the top of the male housing. Continuing to advance the assembly can cause the lock arm of the male housing and the flexible bridge to move out of longitudinal alignment. The flexible bridge can then move upwards to its initial position where it can once again be aligned with the lock arm of the male housing along a transverse axis generally parallel to the top of the male housing. The flexible bridge can contact the top of the male housing when returning to its initial position, which can create a tactile and/or audible feedback signal (e.g., a click sound). In this position, the flexible bridge no longer abuts and engages with the deflecting arm of the CPA member.

Advancing the assembly can cause the center beam of the CPA member, which can be elastically deformed, to deflect. As the flexible bridge is depressed, the flexible bridge can apply a load generally perpendicular to a transverse axis of the CPA member center beam to deflect the center beam in a downward direction away from its undeformed state. As the flexible bridge moves out of alignment with the deflecting arm of the CPA member along a transverse axis generally parallel to the top surface of the CPA member center beam, the components are no longer in blocking engagement. Instead, the CPA member can advance generally along a flat plane toward the rear of the female housing with the center beam deflecting away from its undeformed state along the flat plane. The CPA member deflecting arm, aided by the center beam bias toward its undeformed state along the flat plane, can move over generally curved edges of the lock arm of the male housing and the flexible bridge. The CPA member can continue to advance toward the rear of the female housing until its deflecting arm can abut and engage with the flexible bridge. In an aspect, the CPA member can be aligned with the flexible bridge along a transverse axis generally parallel to the top surface of the CPA member center beam once again. Once the deflecting arm of the CPA member reaches this position, the CPA member is in the final lock position, and the electrical connector is in the fully mated position (e.g., the female housing and the male housing are coupled and fully mated).

Similar to the flexible bridge, in the final lock position, the deflecting arm of the CPA member can abut and engage with the top of the male housing. The contact between the top of the male housing and the deflecting arm of the CPA member when returning to its undeformed state can additionally create a tactile and/or audible feedback signal (e.g., a click sound) signaling that the connector housings are in the fully mated position and coupled with position assurance. Visual feedback can also be provided as the front wall of the CPA member can abut and engage with the front of the female housing. Contact between a rear of the male housing and the rear of the female housing can prevent the male housing from advancing further once the fully mated position is achieved.

The CPA member can also have a grip forming a portion of the front wall. The grip provides an ergonomic surface for individuals to install and remove the CPA from the female housing. The grip can be flared relative to a medial portion of the front wall, defining a concave front surface of the CPA. An individual can engage ends of the front wall defined by the grip to firmly grasp the CPA during installation and removal. Accordingly, the grip can facilitate improved control over the CPA when individuals install and remove the CPA from the female housing. This can mitigate the unintentional application of stresses to portions of the CPA, such as the lateral beams, during installation and removal.

The CPA member cannot be advanced into the final lock position unless the male housing is present. For example, the pre-installed assembly of the female housing and the CPA member does not allow for deflection of the CPA member center beam. Instead, the CPA member is in blocking engagement with the bridge of the female housing such that the CPA member cannot advance generally along a flat plane toward the rear of the female housing. This can prevent unintended deflection of the CPA member center beam.

It is desirable when the male housing and female housing are coupled in the fully mated position to have a high resistance to decoupling. High resistance to decoupling is desirable to prevent the male housing and female housing from returning to the pre-mate position. As such, decoupling from the fully mated position can require overcoming a specified resistance that is greater than the resistance to coupling to the fully mated position. Further, the female housing can include a latch having an upper wall and sidewalls. A channel through which the CPA member can be inserted to form the assembly can be bound by the upper wall and sidewalls of the latch. In the pre-lock position, the CPA member center beam can deflect downwardly in order to advance to the final lock position. In the final lock position, one or more medial walls of the CPA member can abut and engage with the upper wall of the female housing latch. In an aspect, the CPA member can align with the upper wall of the female housing latch along a longitudinal axis generally perpendicular to the top surface of the CPA member center beam. The fit between the latch and the CPA member can prevent further deflection of the CPA member center beam to support the resistance to decoupling from the fully mated position. Overcoming this resistance can be difficult in order to prevent accidental decoupling, but can be done intentionally to provide maintenance to the electrical connector, for example. The CPA member can be released to allow decoupling of the female housing and male housing.

Further, the CPA member can have an aperture in its front wall that reveals a female housing guide member/latch when the CPA member is locked into the connector. Specifically, the aperture reveals a portion of the female housing latch. The female housing latch helps lock the female housing and a male housing together. To release the female housing and male housing, a user can push down on the female housing latch to separate the female housing and male housing. If, for example, the female housing latch is deformed during injection molding, it may not properly lock and release the female housing and male housing. The aperture facilitates quality control by allowing, for example, camera based systems to capture the connection between the female housing latch and the CPA member. Quality control systems can therefore identify if the components exceed tolerances or otherwise do not conform to component requirements. For example, after the CPA member locks into the female housing, a machine can measure the height of the latch or the spacing between the female housing latch and the CPA member. Based on those measurements, the machine can report whether the mating between the female housing and CPA member complies with predetermined tolerances. The predetermined tolerances may be established, for instance, to ensure the CPA member will not shift or inadvertently detach when installed in the connector.

The pre-installed assembly of the female housing and the CPA member can help to prevent components from being detached and/or misplaced. Retention detents of the female housing can fit with one or more cutouts on the lateral beams of the CPA member to retain the CPA member and prevent decoupling of the assembly. In addition, movement of the CPA member to advance from the pre-lock position to the lock position (e.g., deflection of the center beam) can be contained at least partially within the female housing, which can reduce the overall size of the electrical connector. This is beneficial in vehicle wiring systems, for example, that are complex and require numerous components with high reliability, but space is limited. In some aspects, the grooves that receive the CPA member can at least partially contain the movement of the CPA member. Limiting movement of the CPA member to be contained at least partially within the female housing can also limit the overall size of the electrical connector. By containing the center beam deflection movement, for example, connector size in a longitudinal direction can be reduced. The CPA member can additionally include one or more gaps to receive the female housing latch sidewalls, which can deflect downwardly when the bridge is depressed. Receiving the latch sidewalls in the CPA member gaps can reduce connector size in a longitudinal direction as well.

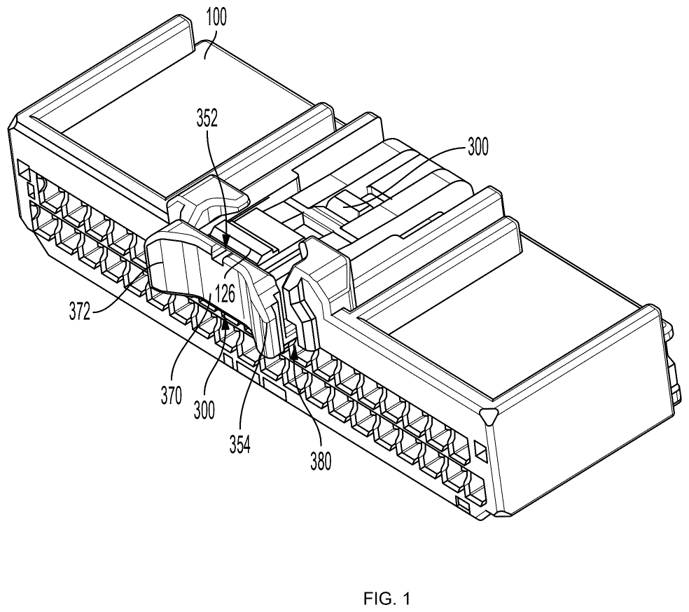

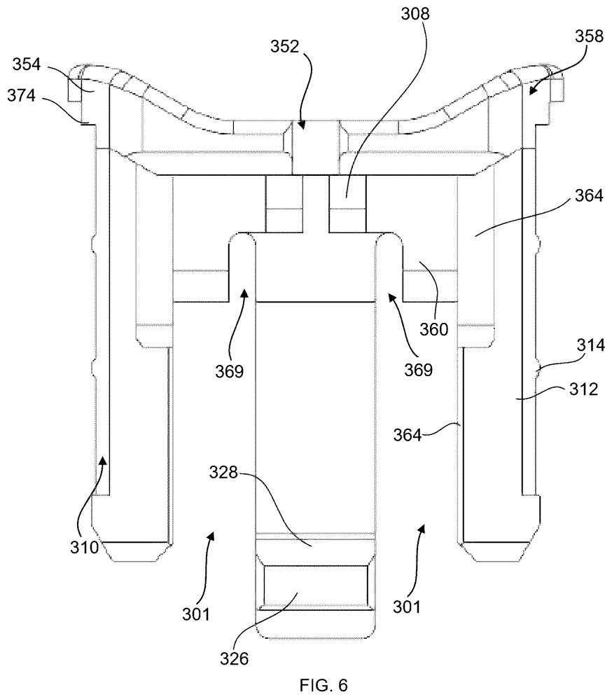

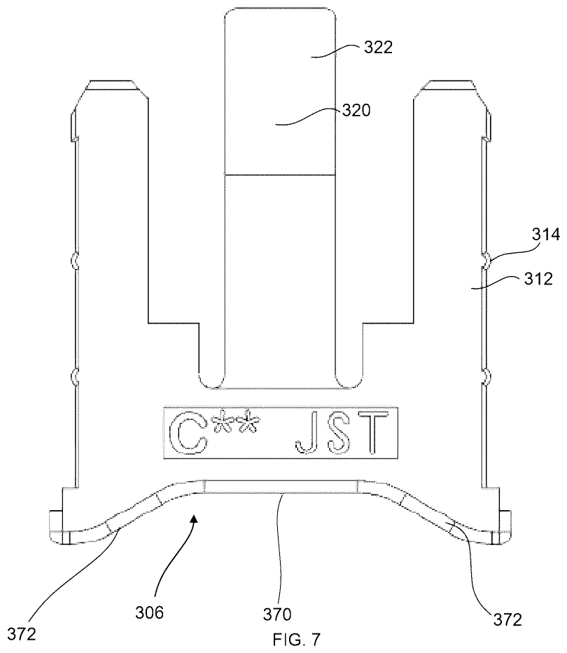

Turning now to FIGS. 1-11, a CPA member 300 engages a female housing 100 as described herein. In some aspects, CPA member 300 includes a grip 354 extending away from female housing 100 that helps individuals remove and install CPA member 300. In some aspects, CPA member 300 has a grip 354 on both sides. Specifically, as shown in FIG. 1, each grip 354 defines a flared front surface 372 of CPA member 300 extending from a medial front surface 370 of CPA member 300. Flared front surfaces 372 flaring away from medial front surface 370, therefore forming a concave front wall 306. Accordingly, an individual can engage grip 354 with their fingers between a front 302 of CPA member 300 and female housing 100. For example, an individual can engage grip 354 by placing their thumb on flared front surface 372 and one or more fingers between grip 354 and female housing 100. Grip 354 helps individuals firmly grasp CPA member 300 to better control CPA member 300 when installing CPA member 300 into female housing 100. The improved control over CPA member 300 supplied by grip 354 can reduce installation and removal time. Improved control over CPA member 300 also mitigates potential inadvertent application of stresses to CPA member 300 that can occur if, for example, an individual's fingers slip while attempting to remove CPA member 300 from female housing 100.

CPA member 300 can include a front 302, a rear 304, a front wall 306, one or more medial walls 308, one or more cutouts 310, one or more lateral beams 312, one or more anti-BSR protrusions 314, a center beam 316, and one or more gaps 301. In some aspects, medial walls 308, lateral beams 312, and center beam 316 all extend from front wall 306 and perpendicular to front wall 306. Center beam 316 can include a top surface 318 and a bottom surface 320. In some aspects, a medial walls 308 are coupled to top surface 318 of center beam 316. Bottom surface 320 can include an inclined edge 322. Center beam 316 can additionally include a lock tip 324 and a deflecting arm 326 having a trailing edge 328 and a leading edge 330.

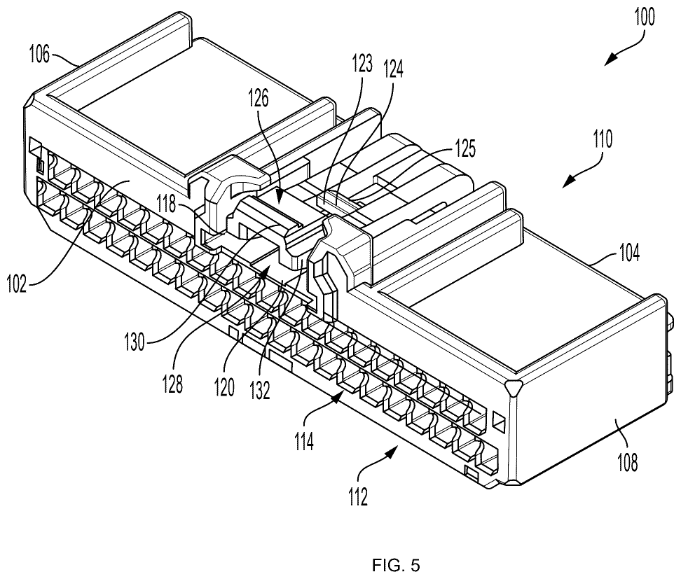

As shown in FIG. 5, female housing 100 can include a front 102, a rear 104, a first side 106, a second side 108, a top 110, a bottom 112, one or more terminal apertures 114, and a bridge 124 having a leading edge 123 and a trailing edge 125. A guide structure of female housing 100 for engaging CPA member 300 can include one or more lateral beam grooves 118, a center beam groove 120, and a latch 126 having an upper wall 130 and sidewalls 132 that define a channel 128. In some aspects, channel 128 is defined above center beam groove 120. Terminal aperture 114 can receive a terminal. In an aspect, bridge 124 can be operatively connected to sidewalls 132. In another aspect, bridge 124 and sidewalls 132 of guide structure can be flexible such that they can be elastically deformed downward to accommodate a male housing. In an aspect, bridge 124 and sidewalls 132 move together, e.g., moving bridge 124 moves sidewalls 132 and vice versa. Channel 128 is configured to receive a portion of CPA member 300. Bridge 124 is configured to engage lock tip 324 of center beam 316 to help secure CPA member 300 in female housing 100, and to engage a downwardly extending arm of a male housing. CPA member 300 may be configured for various female housings and male housings, including those disclosed in U.S. patent application Ser. No. 17/687,306, incorporated herein by reference in its entirety.

In some aspects, front wall 306 is flared to define grip 354 spaced from female housing 100. Grip 354 provides individuals with improved control of CPA member 300 when removing CPA member 300 from female housing 100 relative to other designs. Further, grip 354 presents individuals with increased surface area to push CPA member 300 into female housing 100 relative to other designs. The spacing between grip 354 and female housing 100, and the thickness of grip 354 provides clearance and sufficient surface area for an individual to easily remove and insert CPA member 300 into female housing 100. Specifically, front wall 306 can include medial front surface 370 and flared front surface 372 extending radially from medial front surface 370. Flared front surface 372 forms a front portion of grip 354 that separates portions of front wall 306 from female housing 100. Flared front surface 372 spaces portions of CPA member 300 from female housing 100 without altering the connection between CPA member 300 and female housing 100. For example, flared front surface 372 extends outside of center beam 316, so lock tip 324 and deflecting arm 326 are not affected by grip 354. Additionally, flared front surface 372 extends outside lateral beam 312 so that female housing 100 can receive lateral beam 312 and anti-BSR protrusions 314 without interfering with grip 354.

Grip 354 further includes a contact area 376 defined by, for example, one or more ledges 374 extending behind flared front surface 372. In some aspects, when CPA member 300 engages female housing 100, ledges 374 are disposed between female housing 100 and CPA front 302, and define a recess 380 with female housing 100, as shown in FIG. 1. An individual can engage grip 354 at ledges 374 via recess 380 defined by grip 354 and female housing 100. Ledges 374 provide a textured contact area 376 so an individual can firmly grasp CPA member 300 via grip 354. Although FIGS. 1-4 illustrate cornered ledges 374, ledges 374 can be generally rounded, can define an indent, can define a detent, or can define any other shape providing a textured contact area 376 (e.g., an area having non-uniform surface height so an individual can firmly engage grip 354 with their fingers).

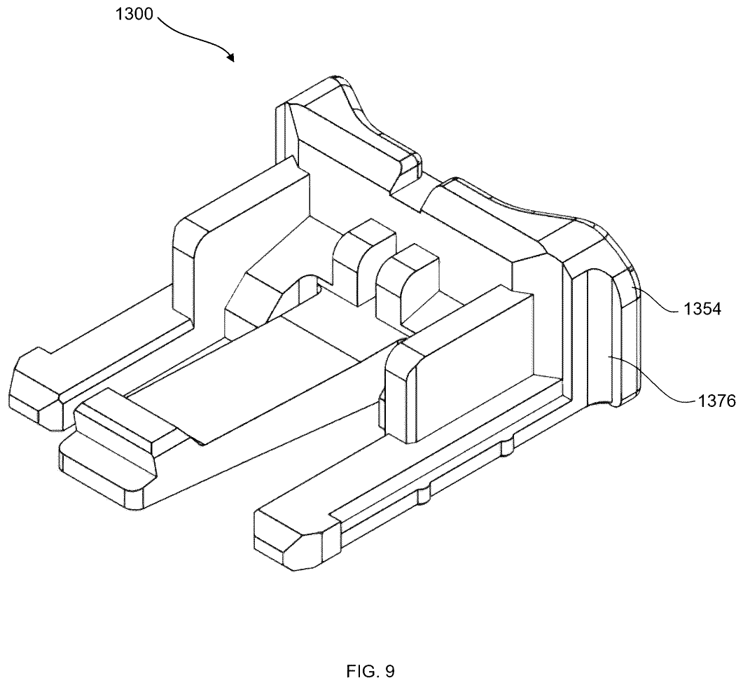

In some aspects, grip 354 includes a generally planar surface, or a curved surface, in place of ledges 374. For example, FIG. 9 illustrates CPA member 1300 having substantially similar features as CPA member 300. CPA member 1300 has a grip 1354 with a curved contact area 1376. Like contact area 376, curved contact area 1376 presents a surface between female housing 100 and CPA member 1300 that a user can engage to securely remove CPA member 3300 from female housing 100. In some aspects, grip 354, 1354 includes one or more protrusions on contact area 376, 1376 that roughen the surface so a user can firmly engage grip 354, 1354 with their fingers.

Contact area 376 defined by, for example, ledges 374 or a curved surface, mitigates the potential that an individual's fingers slip off CPA member 300 when, for example, removing CPA member 300 from female housing 100. By facilitating a firm grasp on CPA member 300, grip 354 can reduce assembly and maintenance time because grip 354 makes it easier to install and remove CPA member 300 from female housing by providing space between CPA member 300 and female housing 100. For example, in some environments, such as a factory, a user wearing gloves may have difficulty removing a CPA member from a female housing if the CPA member is flush with the female housing and the CPA member lacks an ergonomic grip. Without an ergonomic grip, like grip 354, 1354, and the other aspects described herein, a user may not have enough space between a CPA member and a female housing to grab the CPA member with their fingers. The user may resort to digging their fingernails in between the CPA member and the female housing, which can be painful and can damage the CPA member and the female housing.

Further, the firm grasp on CPA member 300 supplied by grip 354 reduces the potential for an individual to inadvertently apply stresses in undesirable directions to, for example, central beam 316, because an individual is less likely to misalign CPA member 300 in female housing 100 due to insufficient control over CPA member 300. Further, an individual is less likely to excessively squeeze CPA member 300 to maintain contact when removing CPA member 300 from female housing 100 because grip 354 provide sufficient surface area on CPA member 300 via contact area 376, and sufficient space between CPA member 300 and female housing 100 via recess 380, to pull CPA member 300 out of female housing 100.

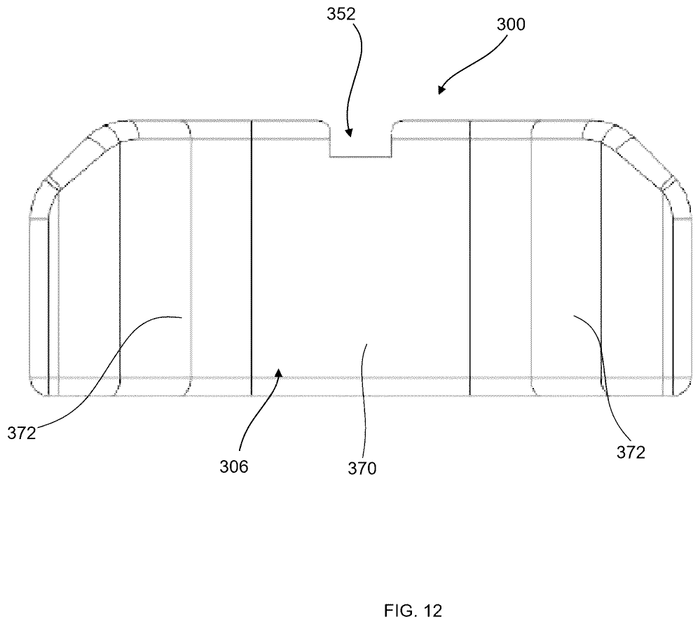

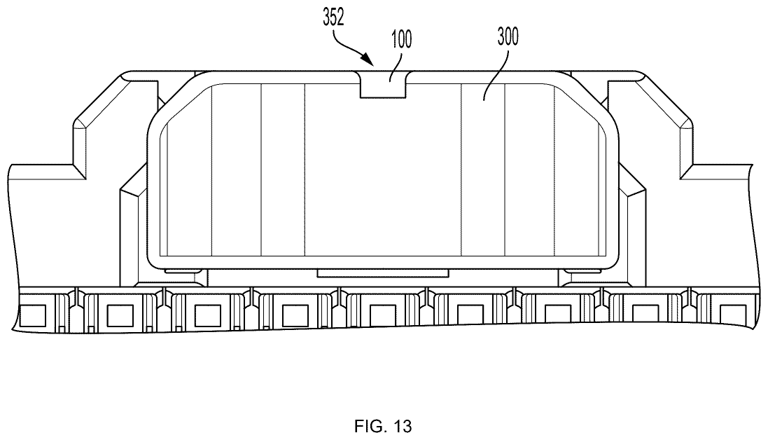

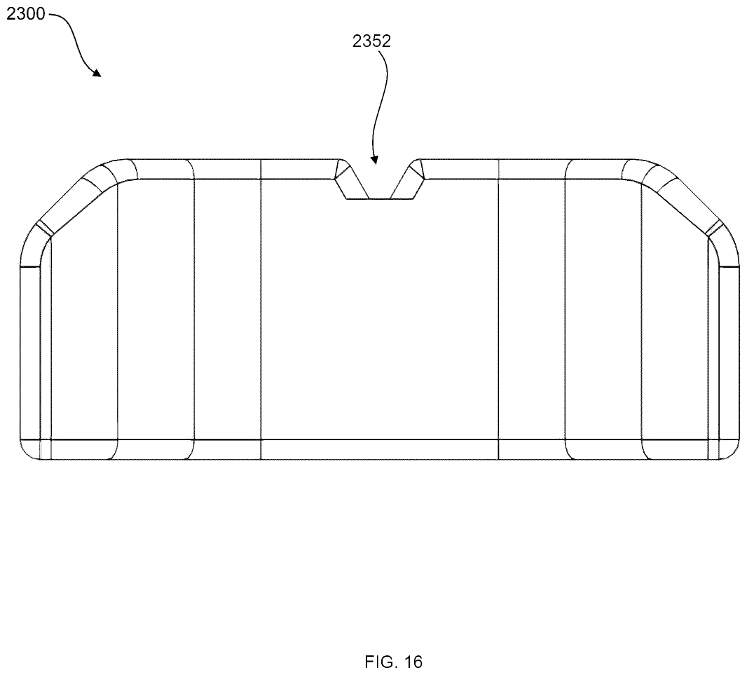

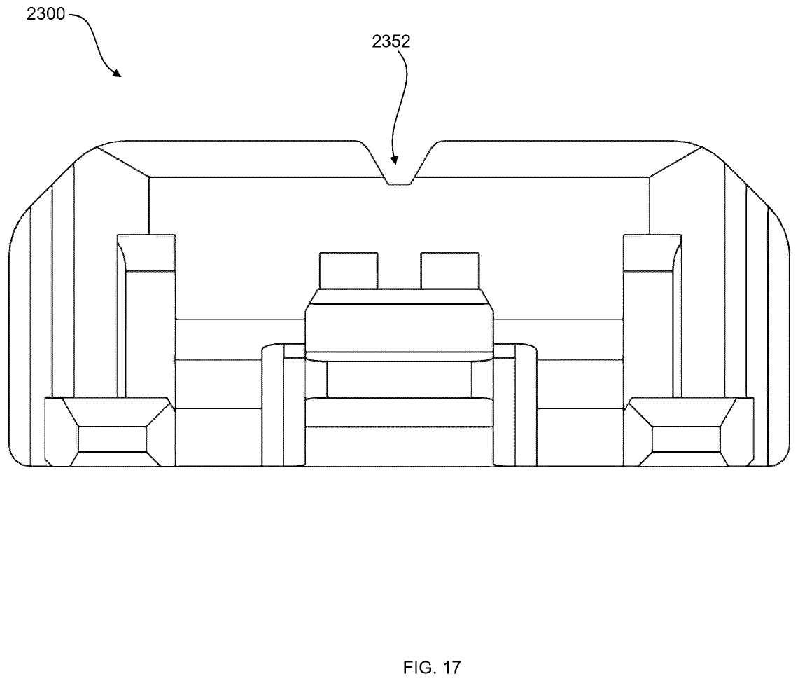

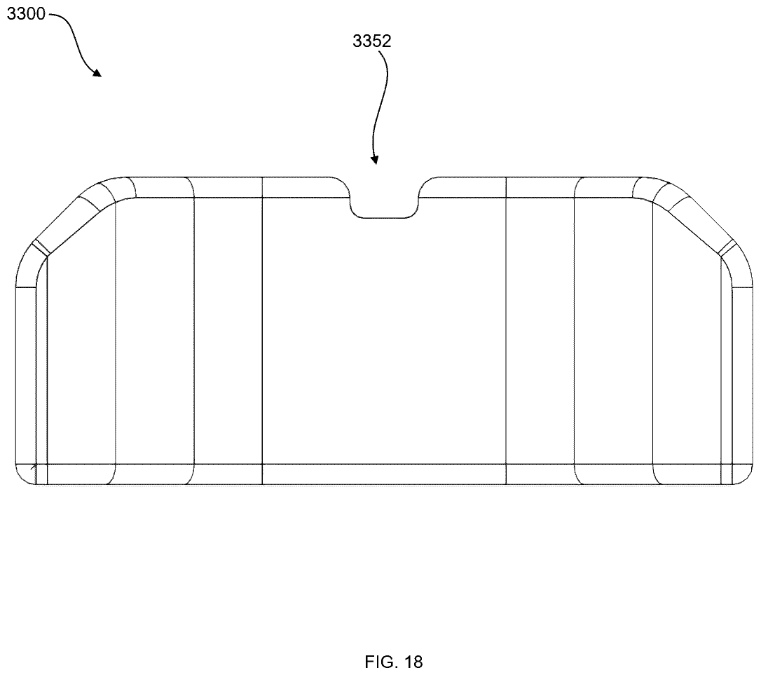

In further aspects, as shown in FIGS. 12-13, CPA member 300 has an aperture 352 configured to reveal a portion of female housing 100 when CPA member 300 is disposed in female housing 100. Aperture 352 is configured to allow vision systems, such as camera-based quality control systems, to confirm that CPA member 300 adequately couples to female housing 100. Female housing latch 126 provides a means to lock and release female housing 300 from a male housing. When female housing 300 is locked with a male housing, deflecting female housing latch 126 can separate female housing 100 from a male housing to release the assembly. By revealing a portion of latch 126, aperture 352 provides a means to identify potential installation or production flaws. For example, if female housing latch 126 is deformed during injection molding, it may not properly secure or release female housing 300 and the male housing. In some aspects, the height of the female housing latch 126 upper wall 130 visible through aperture 352 corresponds to the clearance between female housing 300 and a corresponding male housing. By revealing the female housing latch 126, aperture 352 allows a quality control system to identify that there may be insufficient, or excessive clearance between female housing 300 and a corresponding male housing, that can lead to poor locking or release. In some aspects, aperture 352 can be disposed on an upper edge of medial front surface 370. Aperture 352 can be rectangular, square, v-shaped, u-shaped, or any other cross section suitable to reveal a portion of female housing latch 126. For example, as show in FIGS. 16-17, a CPA member 2300 aperture 2352 is generally v-shaped in some aspects. In other aspects, as shown in FIG. 18, a CPA member 3300 includes an aperture 3352 that is generally u-shaped.

A user may engage CPA member 300 and female housing 100 using a tool, such as a screw driver, to disengage CPA member 300 from female housing 100. In some aspects, aperture 352 is configured to provide sufficient CPA member 300 material that a tool can wedge into to help disengage CPA member 300 from female housing 100. In further aspects, aperture 352 is configured to maximize surface area on front 302 of CPA member 300 so that a user has more surface area to push CPA member 300 into female housing 100.

During assembly, a manufacturer may employ camera based systems to detect if parts of the connector assembly are out of tolerance. Such a camera-based quality control system can view, for example, a female housing guide member/latch 126 through aperture 352. The system can then, for example, report that the connection between CPA member 300 and female housing 100 is misaligned relative to predetermined tolerances. In another example, a vision-based quality control system can confirm and report that CPA member 300 properly locked into female housing 100. In another example, a vision-based quality control system can measure the height of female housing latch 126 through aperture 352 to report whether female housing latch 126 is within tolerances. If the height of female housing latch 126 does not comply with component requirements (e.g., is too short or too tall relative to a predetermined tolerance), the quality control system can report that female housing latch 126 is defective independent of whether CPA member 300 properly aligns with female housing 100 laterally. Alternatively, the quality control system can identify that female housing latch 126 complies with components requirements (e.g., is within a predetermined tolerance), and can subsequently report or log that the height of female housing latch 126 satisfies component requirements.

Measuring alignment between female housing 100 and CPA member 300 and measuring the height of female housing latch 126 can be related, but can require distinct measurements that provide unique information to individuals, such as an operator. For example, checking alignment may involve measuring spacing between female housing latch 126 and CPA member 300, or the angle between surfaces of female housing latch 126 and CPA member 300. Measuring the height of female housing latch 126 can involve measuring the height of female housing latch 126 visible through aperture 352. An alignment check may consider the height of female housing latch 126 to assess vertical alignment. Further, measuring the height of female housing latch 126 can provide an independent indication that dimensions of female housing 100 do not comply with predetermined tolerances and may be the cause of misalignment, as opposed to CPA member 300. By contrast, if the height of female housing latch 126 is within tolerances, but the quality control system reports that female housing 100 and CPA member 300 are not sufficiently aligned, that may indicate CPA member 300 is non-compliant, or that an individual needs to reconnect female housing 100 and CPA member 100. Aperture 352 also allows a vision-based quality control system to identify that both the alignment between CPA member 300 and female housing 100, and the height of female housing latch 126 are compliant and thus report that the connector satisfies component requirements.

In some aspects, CPA member 300 has one or more ribs 358 extending upward from lateral beams 312 and adjacent to front wall 306. In some aspects, ribs 358 extend perpendicular to front wall 306. Ribs 358 may be configured to engage both front wall 306 and lateral beams 312 to sufficiently stiffen lateral beams 312 without introducing undesirable rigidity. An overly rigid lateral beam 312 can introduce an undesirable resistance to flexing during installation and removal of CPA member 300 from female housing 100. For instance, lateral beam 312 flexes to lock into female housing 100, as discussed below. An excessive resistance to flexing could negatively impact the mating between lateral beam 312 and female housing 100.

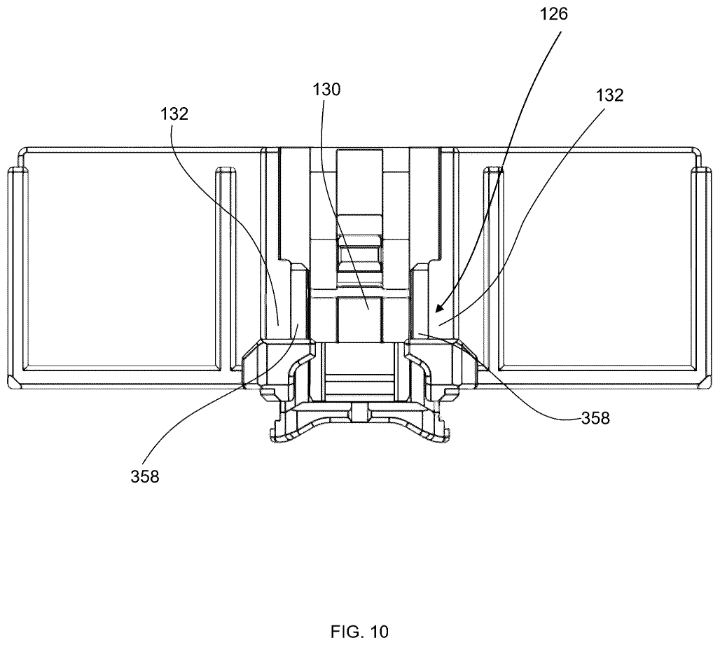

Ribs 358 also restrict horizontal deflection of female housing latch 126 when CPA member 300 enters female housing 100 and when female housing 300 is locked with a male housing by CPA member 300. As shown in FIG. 10, ribs 358 are generally parallel with sidewalls 132 when CPA member engages female housing 100. As discussed above, female housing latch 126 helps lock female housing 100 and a male housing together. A user can depress female housing latch 126 at upper wall 130, causing female housing latch 126 to deflect downward in order to release female housing 100 and a male housing. In some aspects, it may undesirable for sidewalls 132 to deflect horizontally. Ribs 358, being parallel to sidewalls 132, can restrict horizontal deflection of sidewalls 132. In other words, when CPA member 300 is inside female housing 100, ribs 358 border sidewalls 132 and guide female housing latch 126 into proper engagement with a male housing.

Rib 358 may be integral with lateral beam 312 or can be a separate component coupled to lateral beam 312. An integral rib 358 may be desirable to improve manufacturing speed and minimize the number of parts. In some aspect, rib 358 being integral with lateral beam 312 is made of a same material. Connecting rib 358 as a separate component can, for example, introduce different material properties for rib 358 than for lateral beam 312. Distinct material properties between rib 358 and lateral beam 312 can facilitate adequate reinforcement of lateral beam 312 while minimizing weight. For example, rib 358 may be formed from a material having a higher stiffness than the material forming lateral beam 312, so rib 358 can be thinner than if rib 358 were formed from the same material as lateral beam 312, and still adequately reinforce lateral beam 312.

Rib 358 can extend longer, or can extend further in a front 302 to rear 304 direction, than medial wall 308, and can extend shorter than either of the lateral beams 312. In some aspects, rib 358 can extend approximately the same length as lateral beam 312. Further, rib 358 can be shorter, along a height direction, than front wall 306. In some aspects, rib 358 is taller than medial wall 308. Alternatively, ribs 358 can be approximately the same height as medial wall 308 or can be shorter than medial wall 308. Additionally, rib 358 can have a thickness that is approximately the same as the thickness of medial wall 308. Alternatively, ribs 358 can be thinner than medial wall 308 or thicker than medial wall 308 depending on the material properties, such as stiffness, of rib 358 relative to medial wall 308 and the shape of rib 358.

In some aspects, rib 358 selectively stiffens lateral beam 312 in discrete areas. For example, rib 358 can be configured to sufficiently reinforce areas of lateral beam 312 subject to stress concentration without applying the same reinforcement to areas that do not experience the same magnitude of stress or areas where it is desirable for lateral beam 312 to flex. For example, the interface between lateral beam 312 and front wall 306 may be associated with stress concentrations due to the corned nature of the connection between lateral beam 312 and front wall 306. Additionally, it may be desirable for lateral beam 312 to flex horizontally to lock into female housing 100.

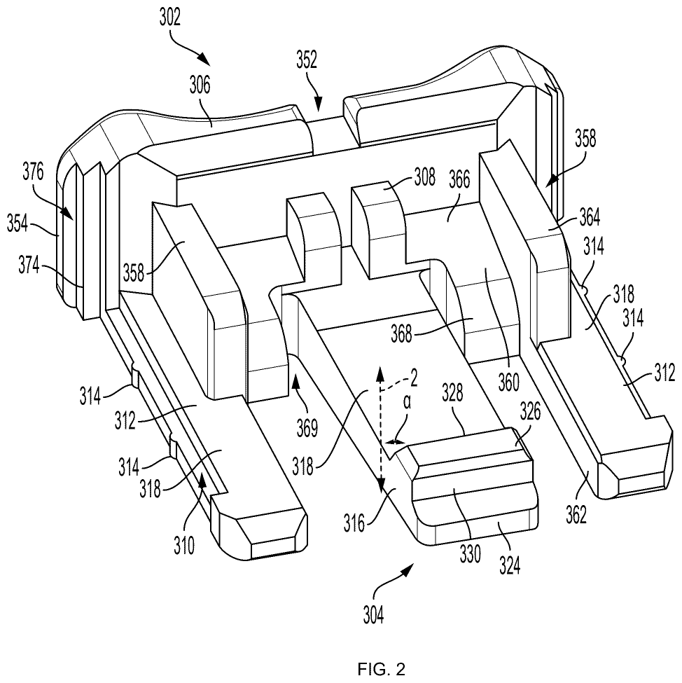

In some aspects, rib 358 has a first portion 362 and a second portion 364 where first portion 362 has a different thickness, height, or length than second portion 364. As shown in FIG. 2, rib first portion 362 engages an internal side (i.e. the side close to center beam 316) of lateral beam 312 and rib second portion 364 engages top surface 318 of lateral beam 312. In some aspects, rib first portion 362 stiffens lateral beam 312 along the length of lateral beam 312 so that lateral beam 312 has sufficient resistance to horizontal bending during installation and removal from female housing 100. Further, rib second portion 364 stiffens lateral beam 312 along a portion of lateral beam 312 adjacent to front wall 306 so that lateral beam 312 has sufficient resistance to upward bending adjacent to the interface between front wall 312 and lateral beam 312. However, while it may be desirable for lateral beam 312 to flex horizontally to lock into female housing 100, it may not be desirable for lateral beam 312 to flex upward at the interface between lateral beam 312 and front wall 306. Accordingly, it may be desirable for lateral beam 312 to have less resistance to horizontal bending along its length than to upward bending at the interface between lateral beam 312 and front wall 306.

Accordingly, this configuration efficiently stiffens lateral beam 312 by selectively concentrating the reinforcement supplied by rib 358 based on considerations such as where stresses concentrate. The selective reinforcement also complements distinct functions of lateral beam 312, such as locking into female housing 100 and connecting lateral beam 312 to front wall 306 because rib 358 includes portions sized to reinforce areas subject to stress concentration and portions sized to maintain adequate flexibility for locking lateral beam 312 into female housing 100. Rib 358 also guides female housing latch 126 into proper engagement with a male housing and prevents horizontal deflection of female housing latch 126 sidewalls 132 when CPA member 300 enters female housing 100 and when CPA member 300 is inside female housing 100.

In further aspects, CPA member 300 includes a brace 360 disposed between lateral beam 312 and center beam 316. In some aspects, brace 360 includes an abutment 366 bridging lateral beam 312 and medial wall 308 adjacent to front wall 306. In some aspects, brace 360 may be shorter and thicker than medial wall 308. In some aspects, brace 360 abut ribs 358 on either side. Brace 360 may be shorter and thicker than rib 358, complementing the reinforcement provided by rib 358 to lateral beam 312 adjacent to front wall 306 and bottom surface 320 of CPA 300 member.

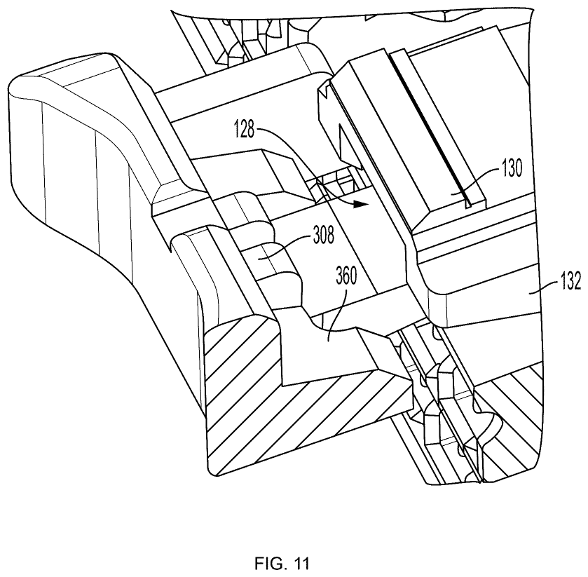

Brace 360 and medial wall 308 also restrict vertical deflection of female housing latch 126 when CPA member 300 is inside female housing 100. Referring to FIG. 11, medial wall 308 is configured to extend below, and contact upper wall 130 of female housing latch 126. Specifically, in some aspects, upper wall 130 and sidewalls 132 can be flexible such that a user can elastically deform upper wall 130 and sidewalls 132 downward to accommodate a male housing when the male housing engages female housing 100. Channel 128 is configured to receive a portion of CPA member 300 having medial wall 308. When female housing 100 and a male housing are locked together by CPA member 300, a user can push down on upper wall 130 of female housing latch 126 to deflect upper wall 130 and sidewalls 132 downward and therefore increase spacing between female housing 100 and the male housing. The increased spacing allows a user to disconnect female housing 100 from the male housing. Pushing down on upper wall 130 can cause sidewalls 132 of female housing latch 126 to deflect downward. Medial wall 308 increases the force required to deflect female housing latch 126, thereby mitigating potential inadvertent decoupling of female housing 100 and a male housing.

Brace 360 also helps secure CPA member 300 and female housing 100 with a male housing. In some aspects, as shown in FIG. 11 brace extends below upper wall 130 and contacts sidewalls 132 of female housing latch 126 when CPA member 300 engages female housing 100. Accordingly, when CPA member 300 engages female housing 100, brace 360 restricts downward deflection of female housing latch 126, thereby increasing the force required to press down on upper wall 130 to decouple female housing latch 100 from a male housing.

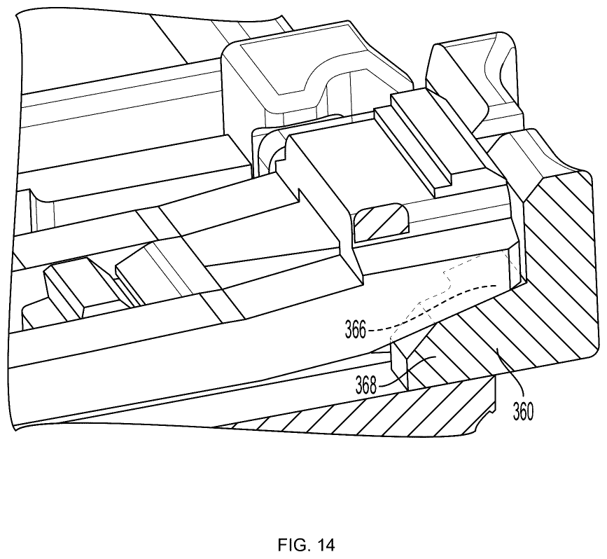

In some aspects, brace 360 has varying thickness. For example, as shown in FIGS. 2 and 14, brace 360 includes a stub 368 extending from abutment 366. In some aspects, abutment 366 engages medial wall 308 and center beam 316. In some aspects, abutment 366 extends from medial wall 308 and center beam 316 at a first thickness, and stub 368 extends from abutment 366 at a height lower than the first height. In some aspects, stub 368 has a decreasing thickness towards a free end. In some aspects, stub 368 extends horizontally from the lateral beam 312 or rib 358 toward center beam 316 to define a pocket 369 there between. Accordingly, brace 360 works in conjunction with rib 358 to efficiently reinforce portions of CPA member 300 subject to high stress concentration or portions of the CPA member 300 where bending is not desirable. As discussed above, the interface between front wall 306 and lateral beam 312 may be subject to stress concentrations due to the cornered connection. The interface between center beam 316 and front wall 306 may similarly experience stress concentrations. Accordingly, brace 360 reinforces the connection between front wall 306 and lateral beam 312 and center beam 316 without impacting the flexure of center beam 316 or lateral beam 316 that facilitates locking CPA member 300 into female housing 100.

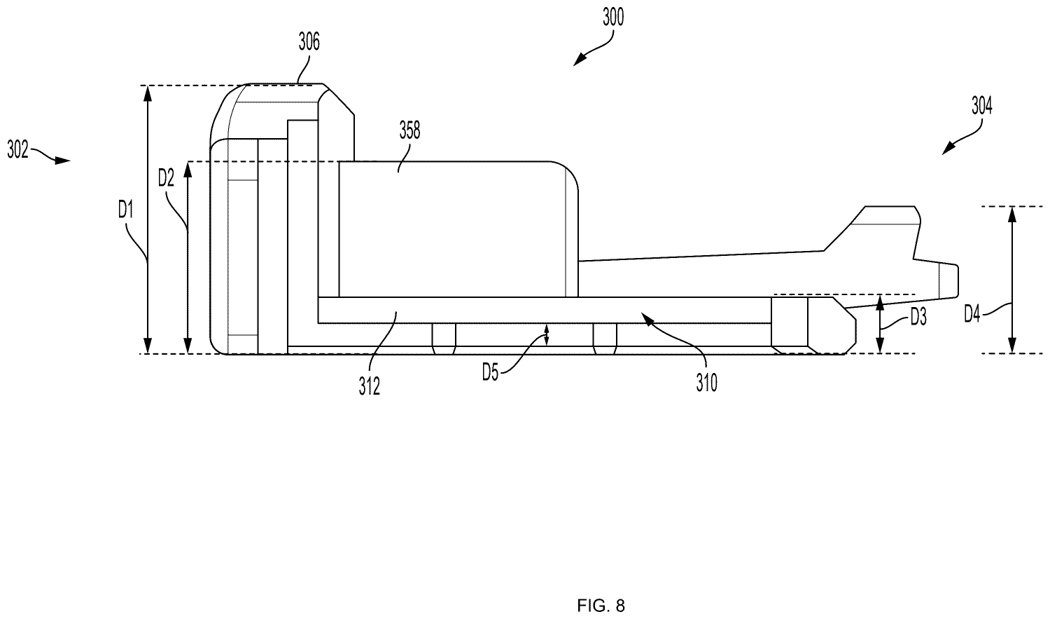

As shown in FIG. 8, in some aspects, the front-most portion of CPA member 300 can be front wall 306. Front wall 306 can reach a first height D1 that is taller than a second height D2 of rib 358. Rib 358 can extend generally perpendicularly from front wall 306 toward rear 304. In some aspects, lateral beams 312 can reach a third height D3 and center beam 316 can reach a fourth height D4, where D3 and D4 are both shorter than first height D1 of front wall 306 and second height D2 of rib 358.

In some aspects, as shown in FIG. 8, each lateral beam can have a cutout 310 for engaging with a retention detent of female housing 100, and the portion of lateral beam 312 below cutout 310 can reach a fifth height D5. In an aspect, anti-BSR protrusions 314 can extend outwardly from lateral beams 312 and reach fifth height D5, which can be shorter than third height D3. Accordingly, lateral beam 312 can include portions at both third height D3 and fifth height D5. In an aspect, the portion of each lateral beam 312 that reaches fifth height D5 can form a lower level of lateral beam 312. In an aspect, the portion of each lateral beam 312 that reaches third height D3 can form an upper level of lateral beam 312.

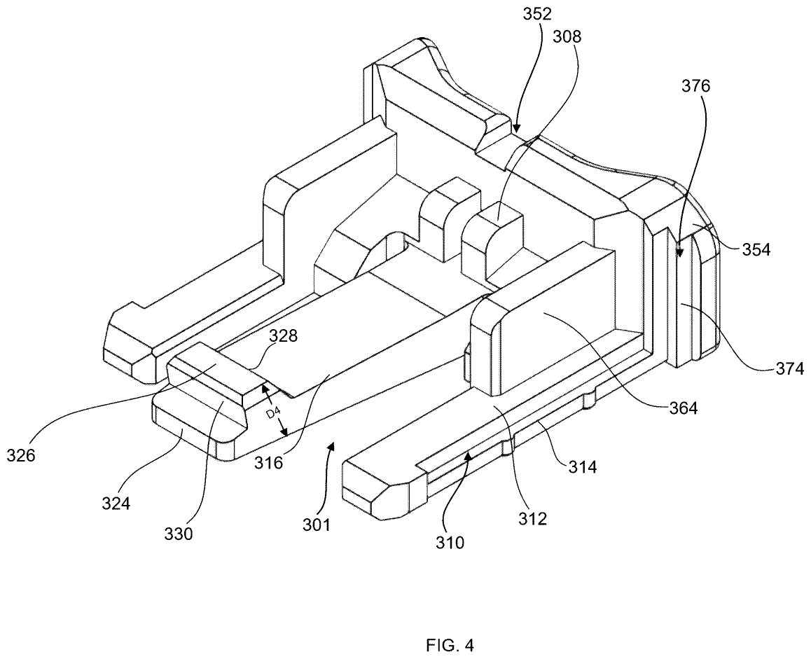

In some aspects, lateral beams 312 and center beam 316 can extend from front 302 toward rear 304, with free ends defining rear 304. In an aspect, center beam 316 can be cantilevered such that it is deflected at an inclined edge 322, with lock tip 324 being the free end. Deflecting arm 326 can be positioned on lock tip 324 and can extend upwardly in a longitudinal direction generally parallel to axis 2 (FIG. 2) from top surface 318. In an aspect, trailing edge 328 can be an abutment edge that can be generally inclined. In another aspect, leading edge 330 can be a retention edge having a generally round interior corner. In an aspect, lateral beams 312 and center beam 316 can be separated by gaps 301 (FIG. 4).

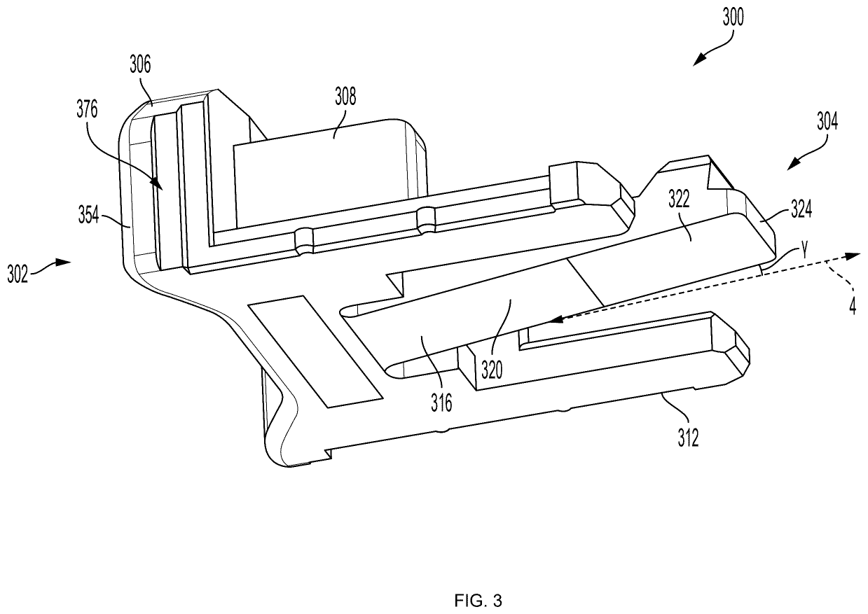

As shown in FIG. 2, in an aspect, the incline of trailing edge 328 can be at an angle, α, from an axis 2 that can be generally perpendicular to top surface 318. In some aspects, angle α can range from approximately 5 degrees to approximately 60 degrees, such as approximately 15 degrees to approximately 45 degrees, such as approximately 30 degrees. As shown in FIG. 3, in an aspect, the incline of inclined edge 322 can be at an angle γ from an axis 4 that can be generally parallel to bottom surface 320. In some aspects, angle γ can range from approximately 5 degrees to approximately 60 degrees, such as approximately 15 degrees to approximately 45 degrees, such as approximately 30 degrees.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the aspects will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A connector position assurance member, comprising:
a front wall comprising a flared front surface defining a grip portion;
a center beam extending from the front wall; and
an upwardly extending deflecting arm extending from a top surface of the center beam and comprising an edge configured to abut a bridge of a connector housing.

2. The connector position assurance member of claim 1, wherein the front wall further comprises a medial front surface, and wherein the flared front surface extends from the medial front surface such that the front wall is concave.

3. The connector position assurance member of claim 2, wherein the front wall further comprises an aperture disposed on an upper edge of the medial front surface, the aperture configured to reveal a portion of the connector housing when the connector position assurance member is coupled to the connector housing.

4. The connector position assurance member of claim 3, wherein the aperture is a rectangular shape.

5. The connector position assurance member of claim 1, wherein the grip portion comprises a contact area behind the flared front surface.

6. The connector position assurance member of claim 5, wherein the contact area is a textured contact area comprising ledges.

7. The connector position assurance member of claim 5, wherein the contact area is a curved contact area.

8. The connector position assurance member of claim 1, wherein the grip portion is configured to define a recess between the connector position assurance member and the connector housing when the connector position assurance member is coupled to the connector housing.

9. A connector position assurance member, comprising:
a front wall;
a center beam extending from the front wall;
a lateral beam extending from the front wall and spaced apart from the center beam; and
a rib coupled to the lateral beam and the front wall, at least a portion of the rib being taller than the lateral beam and shorter than the front wall.

10. The connector position assurance member of claim 9, wherein the rib has different material properties than the lateral beam.

11. The connector position assurance member of claim 10, wherein the rib has higher stiffness than the lateral beam.

12. The connector position assurance member of claim 9, further comprising a medial wall extending from the front wall and coupled to the center beam, wherein the rib is taller than the medial wall.

13. The connector position assurance member of claim 9, wherein the rib comprises a first portion extending along an interior side of the lateral beam and a second portion extending perpendicular from the front wall and engaging a top surface of the lateral beam, the second portion being thicker than the first portion.

14. The connector position assurance member of claim 13, wherein the first portion is configured to stiffen the lateral beam along the length of the lateral beam, and wherein the second portion is configured to stiffen the interference of the lateral beam and the front wall.

15. The connector position assurance member of claim 9, further comprising a brace disposed between the lateral beam and the center beam.

16. The connector position assurance member of claim 15, wherein the brace defines a pocket between the center beam and the brace.

17. The connector position assurance member of claim 15, wherein the brace comprises a first portion and a second portion, the first portion being taller than the second portion.

18. An assembly for a connector, the assembly comprising:
a housing, comprising:
a guide structure;
a latch having an upper wall and sidewalls and defining a channel above the guide structure; and
a bridge; and
a connector position assurance member, comprising:
a center beam disposed in the guide structure;
a medial wall coupled to a top surface of the central beam and disposed in the channel of the latch; and
a deflecting arm extending from a top surface of the center beam and configured to abut the bridge.

19. The assembly of claim 18, wherein the connector further comprises a front wall and an aperture disposed on an upper edge of the front wall, the aperture configured to reveal the latch of the housing.

20. The assembly of claim 19, wherein the connector further comprises a lateral beam and a rib coupled to the lateral beam, the rib being taller than the lateral beam and parallel to the sidewalls of the latch.
